(19) United States
(12) Patent Application Publication
(10) Pub. No.: US 2012/0133162 A1
(43) Pub. Date: May 31, 2012

(54) PRECISION TWEEZERS

(76) Inventor: Nicole SGOBERO, Montignez (CH)

(21) Appl. No.: 13/239,734

(22) Filed: Sep. 22, 2011

Related U.S. Application Data
(63) Continuation of application No. PCT/EP2010/053734, filed on Mar. 23, 2010.

(30) Foreign Application Priority Data
Mar. 23, 2009 (CH) 00436/09

(51) Int. Cl. B25B 9/02

(52) U.S. Cl. 294/99.2

(57) ABSTRACT

Tweezers having two arms designed to be grasped between the thumb and the index for seizing small objects, at least one of said arms being provided with an interchangeable tip. The arms are made of metal or ceramics whilst at least one of the interchangeable tips is made of wood, preferably of boxwood or hornbeam.

### RELATED APPLICATIONS

This application is a continuation of International Application No. PCT/EP2010/053734, filed Mar. 23, 2010, which claims priority to Swiss Application No. CH00436/09, filed Mar. 23, 2009, the contents of which are hereby incorporated by reference in their entirity.

### TECHNICAL FIELD

The present invention concerns precision tweezers, in particular tweezers with interchangeable tips.

### STATE OF THE ART

Tweezers are pincers having two arms designed to be grasped between the thumb and the index for seizing and holding small objects.

There are many different tweezers to satisfy precision requirements in fields such as cosmetics, watchmaking, jewelry-making, medicine or the electronics industry, where it is necessary to seize, hold and examine very small objects. Precision tweezers generally qualify tweezers intended for very precise tasks, for example watchmaker tweezers, jeweler tweezers, medical tweezers etc. They are generally made with very narrow manufacturing tolerances, typically on the order of the tenth of millimeter, which makes it possible to guarantee that the tips close by superimposing exactly over each other even after a high number of movements.

The tips of tweezers, however, tend to get blunt. Furthermore, the manufacturing of multiple shapes of tweezers that often differ only through their tip is costly.

For these reasons, modular tweezers are known in the state of the art which have interchangeable tips. It is thus possible to replace them by keeping the arms. It is also possible to produce a limited number of different arms to achieve a wide range of tweezers by providing them with different tips.

FR2265499 describes tweezers whose interchangeable tips are fastened to the arms by screws or rivets. This connection allows for an accurate positioning but does not enable the tips to be replaced quickly and conveniently.

U.S. Pat. No. 3,677,112 describes plastic tweezers with tips driven into an opening of the pincer's arm.

The tips constitute the tweezers' wearing parts; in order to avoid the inconvenience of having to replace them too frequently, the tips are often made of a different and harder material than that used for the arms.

The tweezers' arms and tips are most often made of metal, for example of steel, surgical steel, gold etc. Using metal for the arms affords the advantage of being elastically deformable, i.e. it can be deformed when a force is applied and reverts to its initial shape when the force is released. Tweezers and tweezers' tips of ceramic materials for example are also known. Tweezers made completely of metal, ceramics or other hard materials have the advantage of being highly resistant to wear and tear but have the disadvantage of scratching the parts held or touched by the tweezers. In the field of watchmaking or jewelry-making, however, one wishes to have parts with an impeccable surface state and without any scratches or marks caused by working with tweezers.

Tweezers made completely of wood are also known. U.S. Pat. No. 7,216,910 describes for example a tong designed to hold food and having two wooden arms. This large-size tool appears designed to be held between the palm of the hand and the thumb; it therefore cannot qualify as tweezers according to the definition here above. Moving the arms towards one another is achieved by deforming the hinge connecting the arms to one another, practically without deformation of the arms themselves.

This tool does not allow precision work on small parts. The fully wooden elongated arms are in fact likely to deform so that the tips do not close exactly over one another.

### BRIEF SUMMARY OF THE INVENTION

One aim of the present invention is to propose tweezers free from the limitations of the known tweezers. In particular, one aim is to propose tweezers adapted to precision watchmaking but that do not scratch the parts held by the tweezers or coming into contact with the tweezers' tips.

According to the invention, these aims are achieved notably by means of tweezers having arms made of a first material, for example of metal, ceramics, composite or plastic materials, and tips made of wood.

These tweezers combine the advantage of durable metallic arms that close in an accurate fashion with the advantages of much softer tips that do not risk scratching the seized parts and that can be easily replaced when they are used. The tips are advantageously interchangeable so that they can be replaced easily.

The use of wood is surprising in this context, this material being usually considered too soft and too difficult to machine with the accuracy required for precision tweezers. Research and tests have however been able to demonstrate that, contrary to this prejudice, at least some kinds of timber are perfectly adapted to the industrial manufacture of tips for precision tweezers. Different examples of suitable tree species are indicated further below.

Tweezers' tips made of wood are also advantageous for applications in electronics, as wood is non conductive and doesn't really charge with static electricity.

### BRIEF DESCRIPTION OF THE FIGURES

Examples of embodiments of the invention are indicated in the description illustrated by the attached figures in which:

FIG. 1 is a perspective view of tweezers according to the invention with wooden tips screwed onto metallic arms.

FIG. 2 is a profile view of the tweezers according to the invention.

FIG. 3 is a perspective view of tweezers according to the invention with wooden tips riveted onto metallic arms.

### EXAMPLE(S) OF EMBODIMENTS OF THE INVENTION

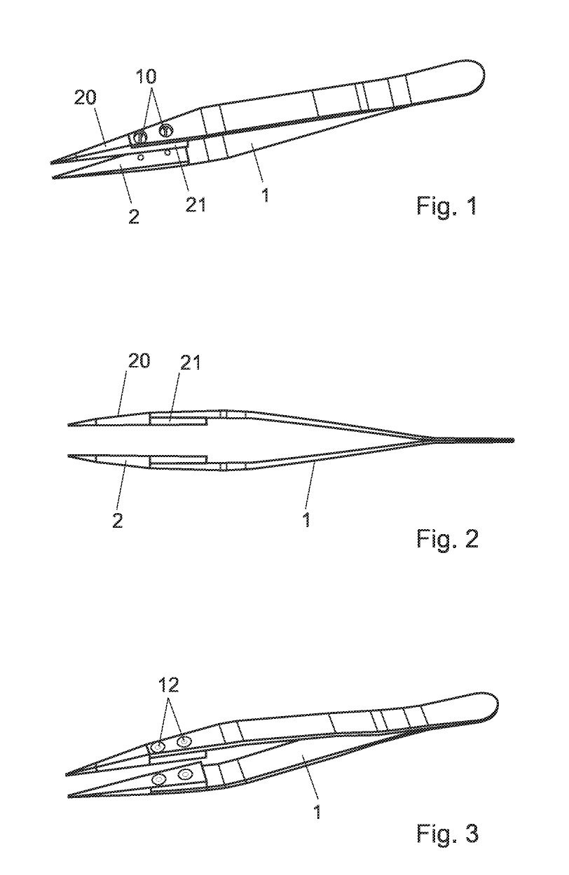

FIG. 1 illustrates an example of tweezers having two arms 1 of non-magnetic and anticorrosive metal, for example of stainless steel, gold, Dumoxel (registered trademark), ceramics, composite or synthetic material. Both arms are welded or riveted one to another. The arms are opened in resting position and have sufficient elasticity to allow the tips to be moved closer towards one another in order to seize an object.

The tweezers of FIG. 1 have two pointed tips 2 fastened in removable fashion to the end of both arms. Other shapes can be used for the tips; a pair of tweezers can thus also be offered and distributed with several pairs of tips of different shapes or sizes. Furthermore, it is also possible to make tweezers with only one removable tip and/or tweezers provided with two tips of different shape, material or type.

According to the invention, the tips 2 are made of wood, which makes it possible to avoid scratching the seized parts or making holes in the parts coming into contact with the tips.

In a preferred embodiment, at least one of the tips 2 is made of boxwood, preferably of European or South American boxwood. In another embodiment, at least one tip is made of hornbeam. The particular selection of these two species has been reached after many tests that have demonstrated that only these species are suitable for the manufacture of tweezers' tips on an industrial scale, with dimensional tolerances on the order of the tenth of millimeter, a hardness adapted for an application for tweezers' tips and excellent resistance to humidity. The timber is advantageously treated to improve resistance to water and to acids.

In the example of embodiment of FIG. 1, both tips 2 are each fastened to the end of an arm 1 by means of two screws 10. The screws pass through traversing holes across the arms 1 and are engaged in holes of smaller diameter in the wood of the tips 2. In an advantageous embodiment, the screws are wood screws that create their own threading when they are screwed in the holes through the tips. This embodiment makes it possible to ensure that the tips are pinned optimally against the arms, with the pressure being controlled by means of the screwing torque.

It is however also possible to use metal screws engaged in previously threaded holes through the wooden tips. This embodiment allows the same tips to be reused several times without deforming them each time they are screwed. It is however more difficult to eliminate the play between the arm and the tip and the pre-threading ex works increases the tip's cost.

In the example of embodiment in FIG. 3, both tips 2 are each fastened at the end of an arm 1 by means of two rivets 12. Assembly and disassembly require in this case a tool less widespread than the simple screwdriver required for disassembling the embodiment of FIG. 1, but the risk of accidental unscrewing is avoided.

Tips clipped onto the arms, as well as tips connected to the arms in a fixed and definitive manner, for example by gluing, can also be used in the frame of the invention, for example for single-use or disposable tweezers. Using interchangeable tips is however particularly advantageous with wooden tips that tend to wear more quickly than the arms.

The tips 2 are advantageously thicker than the end of the arms in order to achieve the required rigidity despite being of wood. In the example illustrated, the tips have an end portion 20, designed to seize the objects, and a fastening portion 21 intended to fasten the tip 2 onto the arm in a removable fashion. The end portion 20 is thicker than the fastening portion 21; the junction between these two portions of different thicknesses thus creates a step 22 defining a portion designed to rest against the extremity of the corresponding arm. The longitudinal position of the tips is thus defined by this resting portion 22 coming to rest against the end of the corresponding arm 1. The lateral alignment of the tips relative to the arms is ensured thanks to screws or rivets; a longitudinal groove, or other alignment means, can also be used.

The tips 2 can be sold independently of the arms 1.

Furthermore, a slightly damaged wooden tip can possibly be repaired or whittled in order to extend its service life.

1. Tweezers having two arms designed to be grasped between the thumb and the index for seizing small objects, at least one of said arms being provided with a tip, the material used for the arms being different from the material used for said tip,
characterized in that said tip is made of wood.

2. Tweezers according to claim 1, at least one tip being fastened to the arm in a removable fashion, the tip being thus interchangeable.

3. Tweezers according to claim 1, wherein said tip (2) is made of boxwood or hornbeam.

4. Tweezers according to claim 1, having an interchangeable wooden tip at the end of each of the two said arms.

5. Tweezers according to claim 1, the interchangeable tip or tips being riveted onto the corresponding arm.

6. Tweezers according to claim 1, the interchangeable tip or tips being screwed onto the corresponding arm.

7. Tweezers according to claim 6, having two screws passing each through a traversing hole across said arm and engaged each in a hole through said wooden tip.

8. Tweezers according to claim 7, said screws being wood screws creating their own threading in the wood of the tips.

9. Tweezers according to claim 7, said screws being metal screws engaging in a threading previously machined in the wood of the tips.

10. Tweezers according to claim 1, said tip or tips having a portion resting against the end of the corresponding arm in order to define the longitudinal position of the tip relative to the arm.

11. Tweezers according to claim 1, said tip or tips being thicker than the extremity of said arms.

12. Tip for tweezers, having fastening means for fastening it in removable fashion onto an arm of tweezers, characterized in that said tip is made of wood.

13. The tip of claim 12, characterized in that it is made of boxwood or hornbeam.

14. The tip of claim 12, provided with two smooth holes designed for it to be screwed with wood screws.

15. The tip of claim 12, provided with two threaded holes.

16. The tip of claim 12, having a seizing portion, a fastening portion provided with said holes, the seizing portion being thicker than the fastening portion so as to define a resting portion at the junction between the seizing portion and the fastening portion, said resting portion being parallel to the axis of said holes.
